(19) United States
(12) Patent Application Publication
(10) Pub. No.: US 2022/0194338 A1
(43) Pub. Date: Jun. 23, 2022

(54) ELECTROMECHANICAL BRAKE SYSTEM, CONTROL METHOD THEREOF AND COMPUTER READABLE MEDIUM

(71) Applicants: Haldex VIE (Shanghai) Electromechanical Brake System Co., Ltd., Shanghai (CN); Haldex Brake Products Aktiebolag, Landskrona (SE)

(72) Inventor: Anders Nilsson, Shanghai (CN)

(21) Appl. No.: 17/690,048

(22) Filed: Mar. 9, 2022

Related U.S. Application Data
(63) Continuation of application No. PCT/EP2020/073828, filed on Aug. 26, 2020.

(30) Foreign Application Priority Data
Sep. 10, 2019 (CN) 201910852949.7

(51) Int. Cl. B60T 8/88; B60T 13/74; B60T 17/22; B60Q 9/00; B60T 8/92

(52) U.S. Cl. CPC B60T 8/885; B60T 13/746; B60T 17/22; B60T 2270/414; B60T 8/92; B60T 2270/406; B60Q 9/00

(57) ABSTRACT

The present invention relates to an electromechanical brake system (7) and a control method of the electromechanical brake system (7). The electromechanical brake system (7) comprises an electric power source and at least one electric brake device powered by the electric power source to generate a braking force responsive to a braking demand, the electromechanical brake system (7) is configured to adjust braking performance of the electric brake device according to an actual energy level of the electric power source. The present invention can timely adjust the braking performance of the electric brake device, and promptly inform the driver of the braking situation, so that the driver can obtain an intuitive braking feeling during the driving process, thereby effectively improving the safety of the vehicle, and at the same time it saves the energy of the electric power source, and avoids unnecessary energy consumption, thereby playing a good role in protecting the electromechanical brake system (7).

### CROSS REFERENCE TO RELATED APPLICATIONS

This application is a continuation of International Application PCT/EP2020/073828 with an international filing date of Aug. 26, 2020 and claiming priority to co-pending Chinese Patent Application No. CN 201910852949.7 entitled “Electromechanical brake system and control method thereof”, filed on Sep. 10, 2019.

### FIELD OF THE INVENTION

The present invention relates to the technical field of electronic machinery control, and more particularly to an electromechanical brake system and a control method thereof.

### BACKGROUND OF THE INVENTION

Vehicles are essential to the daily traffic of people and have a high penetration rate. In order to avoid obstacles around the car, it is often necessary to use a brake device to reduce the moving speed of vehicles or even stop the movement of vehicles during driving.

The conventional brake device is usually a brake disc that uses a mechanical drive such as a hydraulic pressure structure to drive brake pads against the brake disc for frictionally resisting its rotation, thereby achieving the purpose of braking.

In order to enhance the braking ability of vehicles, especially large vehicles, and to simplify the structure of brake system, the prior art further proposes an electromechanical brake (EMB) system.

An actuator of the conventional electromechanical brake system may comprise an electric power source and an electric brake device powered by the electric power source to generate a braking force. The electric brake device may further comprise a motor for generating a braking force, and a mechanical actuator driven by the motor.

In general, when a driver depresses the brake pedal, the motor controller can control the rotation of the motor to drive the mechanical actuator to generate the braking force after receiving a command.

In a brake system using a transmission medium such as a hydraulic pressure or a pneumatic pressure, the brake clamping force is reduced as the pressure drops due to, for example, a leak. Therefore, when an abnormality in the brake system causes the pressure drop, the driver will obviously feel a braking performance degradation caused by insufficient braking force.

However, in the electromechanical brake system, since the source of the braking force is an electrically driven motor, this characteristic causes the braking force generated by the electric brake device to be unaffected even when the actual energy level of the electric power source is insufficient. The driver cannot intuitively feel the abnormality of the brake system through the braking performance degradation, which greatly affects the driving safety of the vehicle.

### SUMMARY OF THE INVENTION

A brief overview of one or more aspects is provided below to provide a basic understanding of these aspects. The summary is not an extensive overview of all of the aspects that are contemplated, and is not intended to identify key or decisive elements in all aspects. The sole purpose of the summary is to present some concepts of one or more aspects in a simplified form as a prelude to the more detailed description that is presented later.

In order to overcome the defects in the prior art for a vehicle using an electromechanical brake system that the driver is unable to know the abnormality of the brake system in time, the present invention provides an electromechanical brake system and a control method thereof.

The present invention solves the technical problem by the following technical solutions.

An electromechanical brake system, the electromechanical brake system comprises an electric power source and at least one electric brake device powered by the electric power source to generate a braking force responsive to a braking demand, the electromechanical brake system is configured to adjust braking performance of the electric brake device according to an actual energy level of the electric power source.

Optionally, the electromechanical brake system is configured to reduce braking performance of the electric brake device when the actual energy level of the electric power source is lower than a predetermined threshold.

Optionally, the electromechanical brake system is configured to stop reducing the braking performance of the electric brake device when the braking demand is higher than a predetermined emergency threshold.

Optionally, the electromechanical brake system comprises a power diagnostic module for detecting the actual energy level and/or a performance of the electric power source.

Optionally, the braking performance is reduced to a predetermined level.

Optionally, the electromechanical brake system is configured to output a warning signal when the actual energy level of the electric power source is lower than a warning threshold, the warning threshold is higher than the predetermined threshold.

Optionally, the electromechanical brake system is configured to carry out automatic stopping when the actual energy level of the electric power source is lower than an automatic stopping threshold, the automatic stopping threshold is lower than the predetermined threshold.

Optionally, parking brake is applied after the automatic stopping is completed.

Optionally, the braking performance comprises braking force and/or braking response time.

Optionally, the electromechanical brake system comprises a plurality of the electric power sources, each of the electric power sources supplies power for at least one of the electric brake devices, the electromechanical brake system is configured to reduce braking performance of the electric brake device powered by any one of the electric power sources whose actual energy level is lower than the predetermined threshold or reduce braking performance of all of the electric brake devices when the actual energy level of any one of the electric power sources is lower than the predetermined threshold.

Optionally, the electromechanical brake system comprises an ECU (Electronic Control Unit), the ECU is configured to adjust braking performance of the electric brake device based on the received braking demand and the actual energy level of the electric power source.

Optionally, the electromechanical brake system comprises an axle control unit corresponding to an axle, each axle control unit controls electric brake devices at both ends of the axle, the axle control unit is configured to adjust braking performance of the electric brake device based on the received braking demand and the actual energy level of the electric power source.

Optionally, the electric power source comprises a capacitor-based power source and/or a battery.

A control method of electromechanical brake system, the electromechanical brake system comprises an electric power source and at least one electric brake device powered by the electric power source to generate a braking force responsive to a braking demand, the control method comprises, adjusting braking performance of the electric brake device according to an actual energy level of the electric power source.

Optionally, the adjusting braking performance of the electric brake device according to an actual energy level of the electric power source comprises, reducing braking performance of the electric brake device when the actual energy level of the electric power source is lower than a predetermined threshold.

Optionally, the control method further comprises, stop reducing the braking performance of the electric brake device when the braking demand is higher than a predetermined emergency threshold.

Optionally, the control method further comprises, detecting the actual energy level and/or a performance of the electric power source through a power diagnostic module.

Optionally, the reducing braking performance of the electric brake device comprises, the braking performance is reduced to a predetermined level.

Optionally, the control method further comprises, outputting a warning signal when the actual energy level of the electric power source is lower than a warning threshold, the warning threshold is higher than the predetermined threshold.

Optionally, the control method further comprises, carrying out automatic stopping when the actual energy level of the electric power source is lower than an automatic stopping threshold, the automatic stopping threshold is lower than the predetermined threshold.

Optionally, parking brake is applied after the automatic stopping is completed.

Optionally, the braking performance comprises braking force and/or braking response time.

Optionally, the electromechanical brake system comprises a plurality of the electric power sources, each of the electric power sources supplies power for at least one of the electric brake devices, the adjusting braking performance of the electric brake device according to an actual energy level of the electric power source comprises, reducing braking performance of the electric brake device powered by any one of the electric power sources whose actual energy level is lower than the predetermined threshold or reducing braking performance of all of the electric brake devices when the actual energy level of any one of the electric power sources is lower than the predetermined threshold.

Optionally, the electromechanical brake system comprises an ECU, the control method comprises, adjusting, by the ECU, braking performance of the electric brake device based on the received braking demand and the actual energy level of the electric power source.

Optionally, the electromechanical brake system comprises an axle control unit corresponding to an axle, each axle control unit controls electric brake devices at both ends of the axle, the control method comprises, adjusting, by the axle control unit, braking performance of the electric brake device based on the received braking demand and the actual energy level of the electric power source.

Optionally, the electric power source comprises a capacitor-based power source and/or a battery.

A computer readable medium, having stored thereon computer instructions that, when executed by a processor, implement the steps of the control method of the electromechanical brake system.

The various preferred conditions can be arbitrarily combined on the basis of the common knowledge in the art, that is, the embodiments of the present invention are obtained.

The positive effects of the present invention are as follows.

The present invention can timely adjust the braking performance of the electric brake device and promptly inform the driver of the braking situation, so that the driver can obtain an intuitive braking feeling during the driving process, thereby effectively improving the safety of the vehicle, and at the same time it saves the energy of the electric power source and avoids unnecessary energy consumption, thereby playing a good role in protecting the electromechanical brake system.

### BRIEF DESCRIPTION OF THE DRAWINGS

The above features and advantages of the present invention will be better understood after reading the detailed description of the embodiments of the present disclosure in conjunction with the following figures. In the figures, components are not necessarily drawn to scale, and components having similar related features may have the same or similar reference numerals.

FIG. 1 shows a system architecture diagram of an electromechanical brake system according to an embodiment of the present invention.

FIG. 2 shows a system architecture diagram of an electromechanical brake system according to another embodiment of the present invention.

FIG. 3 shows a system architecture diagram of an electromechanical brake system according to another embodiment of the present invention.

FIG. 4 is shows a schematic diagram of changes in braking performance according to an embodiment of the present invention.

FIG. 5 shows a schematic diagram of voltage and braking performance according to an embodiment of the present invention.

FIG. 6 shows a schematic diagram of voltage and braking performance according to another embodiment of the present invention.

FIG. 7 shows a schematic diagram of braking performance and braking demand according to an embodiment of the present invention.

FIG. 8 shows a flowchart of a control method of electromechanical brake system according to an embodiment of the present invention.

### DETAILED DESCRIPTION

The present invention is described in detail below with reference to the drawings and specific embodiments. It is to be noted that the aspects described below in conjunction with the drawings and the specific embodiments are merely exemplary and are not to be construed as limiting the scope of the present invention.

The following description is presented to enable those skilled in the art to make and use the present invention. Various modifications and various uses in different applications will be readily apparent to those skilled in the art, and the general principles defined herein are applicable to a wide range of embodiments. Thus, the present invention is not limited to the embodiments set forth herein, but the scope of the broadest scope of the principles and novel features disclosed herein.

In the following detailed description, numerous specific details are set forth. However, it is apparent to those skilled in the art that the practice of the invention may not be limited to the specific details. In other words, well-known structures and devices are shown in block diagram form and not shown in detail to avoid obscuring the present invention.

In the description of the present invention, it should be noted that the terms “set”, “install”, and “connected” should be understood broadly, and may be a fixed connection, for example, unless otherwise specifically defined and defined. It may be a detachable connection, or an integral connection. It may be a mechanical connection or an electrical connection. It may be directly connected, or may be indirectly connected through an intermediate medium, and may be internal communication between the two elements. The specific meaning of the above terms in the present invention can be understood in a specific case by those skilled in the art.

The present invention provides an embodiment of an electromechanical brake (EMB) system, the electromechanical brake system comprises an electric power source and at least one electric brake device powered by the electric power source to generate a braking force responsive to a braking demand, the electromechanical brake system is configured to adjust braking performance of the electric brake device according to an actual energy level of the electric power source, so that the driver can obtain an intuitive braking feeling during the driving process, thereby effectively improving the safety of the vehicle, and at the same time it saves the energy of the electric power source.

In this embodiment, the actual energy level corresponds to the remaining useful amount of energy in an energy storage device, namely the electric power source, and may also be a correlation index for measuring the remaining useful amount of energy of the energy storage device. As long as it can be used to measure the remaining useful amount of energy of the energy storage device, it can be set according to actual conditions and user requirements.

An actuator of the electromechanical brake system may comprise a brake motor for generating the braking force, and a mechanical actuator driven by the brake motor. For example, in a disc brake, the mechanical actuator may comprise a transmission mechanism and a caliper. In a drum brake, the mechanical actuator may comprise a transmission mechanism and a brake shoe.

When a driver depresses the brake pedal, a corresponding brake demand is generated, and the controller controls the rotation of the brake motor according to the braking demand, thereby driving the mechanical actuator to generate the braking force.

When the driver releases the brake pedal, the controller reduces the braking force or completely releases the brake according to the braking demand.

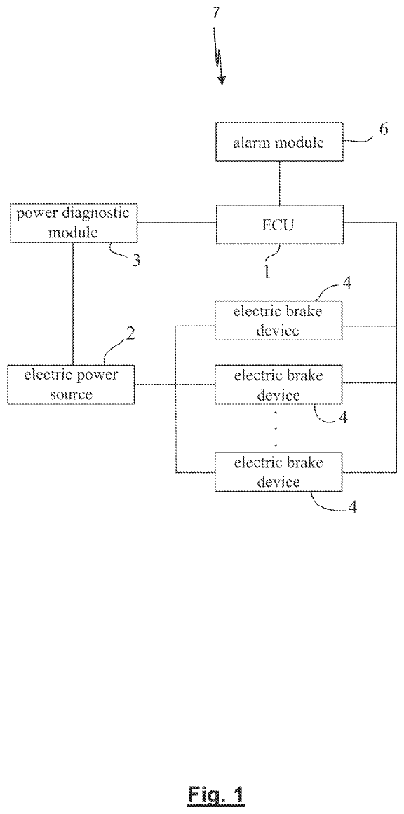

As an embodiment of the electromechanical brake system, as shown in FIG. 1, the electromechanical brake system 7 comprises an ECU 1, an electric power source 2, and at least one electric brake device 4.

In this embodiment, the electric power source 2 exemplarily employs or comprises a capacitor-based power source.

The above-mentioned electric power source 2 is mainly used to supply the above-mentioned electromechanical brake system 7 with the energy required to drive the brake motor that generates the braking force. In order to meet the demand for the braking force generated by the motor, the electric power source 2 comprises, but is not limited to, an ultra-capacitor group composed of a plurality of ultra-capacitor units in series, in parallel or a combination of series and parallel connection.

The electromechanical brake system 7 may obtain energy from an energy storage battery of the vehicle, and charge the electric power source 2 by means of prior art methods well known to those skilled in the art, such as voltage conversion. Therefore the electric power source 2 may directly output electric energy to the motor to generate a braking force in response to a brake demand.

Those skilled in the art may understand that the structure of the electric power source 2, and the solution that obtaining energy from an energy storage battery of the vehicle, are only specific embodiments provided in the present invention, mainly for more clearly showing the concept of the present invention to the public, and providing a feasible solution, but not intended to limit the scope of the invention.

For example, the electric power source 2 may comprise only a battery or a capacitor-based power source that may be directly powered by a production mechanism such as a vehicle engine. Moreover, the electric power source 2, in addition to employ a centralized arrangement that a single power source supplying energy to each electric brake device 4 as shown in FIG. 1, may also employ a distributed arrangement corresponding to the electric brake device 4. Or the electric brake device 4 at each end of each axle is powered by one electric power source 2. In other embodiments, those skilled in the art may also use other means to obtain the energy required to drive the brake motor.

As another embodiment, as shown in FIG. 1, the electromechanical brake system 7 further comprises a power diagnostic module 3. The power diagnostic module 3 is communicatively connected to the electric power source 2.

The power diagnostic module 3 is configured to detect the performance of the electric power source 2, and to evaluate the power storage capability of the electric power source 2 based on its performance, thereby more accurately determining the actual energy level of the electric power source 2.

Specifically, when the electric power source 2 uses an energy storage battery, an ultra-capacitor group, or a combination thereof, its performance will attenuate with the use time, and its power storage capacity will decrease, that is, the maximum power storage capacity will be reduced. Therefore, the actual energy level is calculated by comprehensively evaluating the performance of various parameters, such as voltage, charge and discharge current, temperature or ESR (Equivalent Series Resistance). The power diagnostic module 3 can be implemented by prior art means well known to those skilled in the art.

According to the centralized arrangement or the distributed arrangement of the electric power source 2, the power diagnostic module 3 can also be arranged as one or more correspondingly.

In this embodiment, at least one electric brake device 4 can be respectively disposed at a plurality of wheel ends of the vehicle to reduce the speed of the vehicle or to apply parking brake.

The electric brake device 4 may comprise a brake motor. The brake motor may obtain electric power from the electric power source 2 via the power supply circuit of the electric brake device 4, thereby generating a braking force required to reduce the speed of the vehicle.

In this embodiment, the ECU 1 is configured to adjust braking performance of the electric brake device 4 based on the received braking demand and the actual energy level of the electric power source 2.

The braking performance comprises braking force, that is, the braking force and/or braking response time (corresponding to braking retardation) output by the electric brake device 4.

Specifically, the ECU 1 is configured to acquire the actual energy level of the electric power source 2 in real time, and to reduce braking performance of the electric brake device 4 when the actual energy level of the electric power source 2 is lower than a predetermined threshold. The adjustment of the braking performance can be achieved by processing the braking demand obtained from the driver, for example, adjusting the signal acquired from the brake pedal, and also by controlling the electric brake device 4, for example, adjusting the control signal output to the electric brake device 4.

The predetermined threshold is not specifically limited in this embodiment, and the predetermined threshold may be set according to the hardware condition of the electromechanical brake system 7 and the user requirement, and the predetermined threshold may also be divided into multiple predetermined thresholds, to form multiple forms of adjustment.

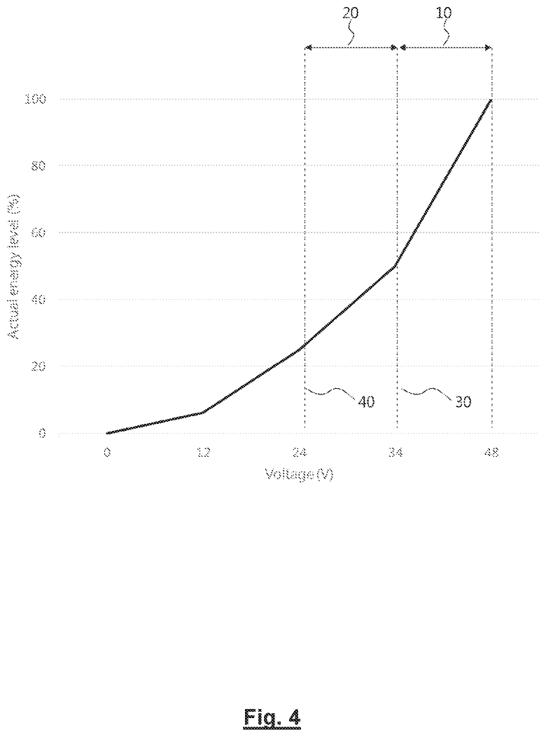

As an embodiment, the electric power source 2 employs the capacitor-based power source, such as an ultra-capacitor group. Depending on the characteristics of the ultra-capacitor group, its voltage value can be used to assess its actual energy level. As shown in FIG. 4, when the electric power source 2 exemplarily employs 48 V ultra-capacitor group, the theoretical value of its actual energy level is as shown, for example, at a voltage of 24 V, its actual energy level is 25%. The braking performance is divided into two levels, a first braking performance 10 and a second braking performance 20, respectively.

FIG. 4 to FIG. 6 each show the case of using the 48 V ultra-capacitor group, but the embodiment is not limited to the 48 V ultra-capacitor group, and the corresponding selection and adjustment can be performed according to actual conditions.

The braking performance is set to the first braking performance 10 when the actual energy level of the capacitor-based power source is higher than or equal to a first predetermined threshold 30 (e.g., set to 50% actual energy level).

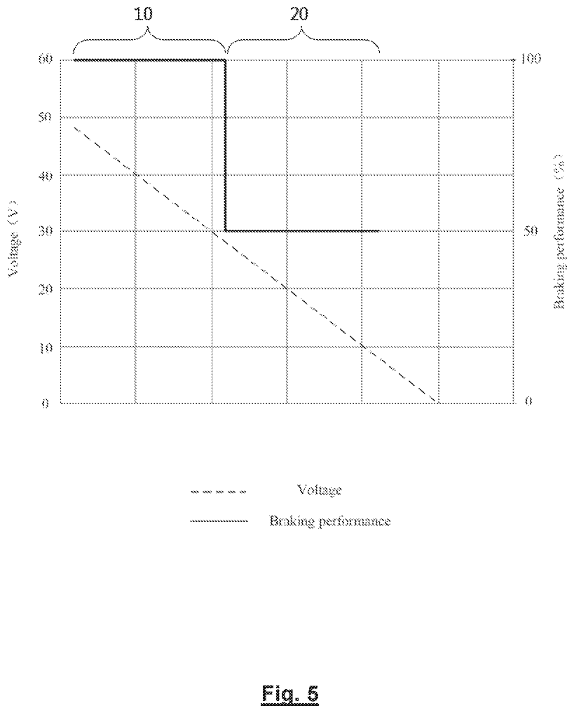

As shown in FIG. 5, at the first braking performance 10, the electric brake device 4 maintains 100% of the braking performance. At this time, the vehicle outputs a corresponding braking force according to the generated braking demand, and the driver obtains a normal braking feeling.

Typically, when the braking energy is consumed, the capacitor-based power source can replenish the energy from, such as the energy storage battery of the vehicle, so that its actual energy level is always maintained above the first predetermined threshold 30. When the brake system or the vehicle system is abnormal, and the capacitor-based power source cannot be replenished, the actual energy level of the capacitor-based power source is consumed below the first predetermined threshold 30, with the energy consumption of the brake. At this time, the ECU 1 sets the braking performance to the second braking performance 20.

At the second braking performance 20, the braking performance of the electric brake device 4 is reduced to a predetermined level, such as 50% of the braking performance, that is, the output of the braking force is dropped to 50% of the first braking performance 10 and/or the braking response time is extended to 200% of the first braking performance 10. At this time, the driver will obviously feel the decline in the braking performance when the driver depresses the brake pedal, thereby achieving the effect of prompting an abnormality of the brake system.

When the driver feels that the brake system is abnormal, braking is usually performed to stop the vehicle to ensure safety. By setting an appropriate first predetermined threshold 30, it is possible to ensure that its actual energy level is sufficient to fully brake the vehicle until it is stationary. However, if the driver cannot brake at this time, or if other abnormalities in the system cause the driver's brake input to be unsuccessful, the brake system needs to be forcedly braked.

For example, when the actual energy level of the capacitor-based power source is lower than the first predetermined threshold 30 and continues to decrease, if the vehicle is not stopped, a huge safety hazard may occur when the actual energy level drops to the point where the vehicle cannot be stopped. Therefore, a second predetermined threshold 40 is set (e.g., set to 25% of the total amount of electricity), and when the actual energy level continues to decrease below the second predetermined threshold 40, the brake system enforces automatic stopping, that is, utilizes the remaining charge decelerates the vehicle to a complete standstill. Therefore, the second predetermined threshold 40 is also the automatic stopping threshold, which should be set to ensure that its corresponding actual energy level is sufficient to completely stop the vehicle. After the vehicle is completely stopped, in order to further increase safety, a parking brake can also be applied. In the case where the electric brake device is integrated with the parking brake function, it can be used directly for applying parking brake, or an additional parking brake device can be used for applying parking brake.

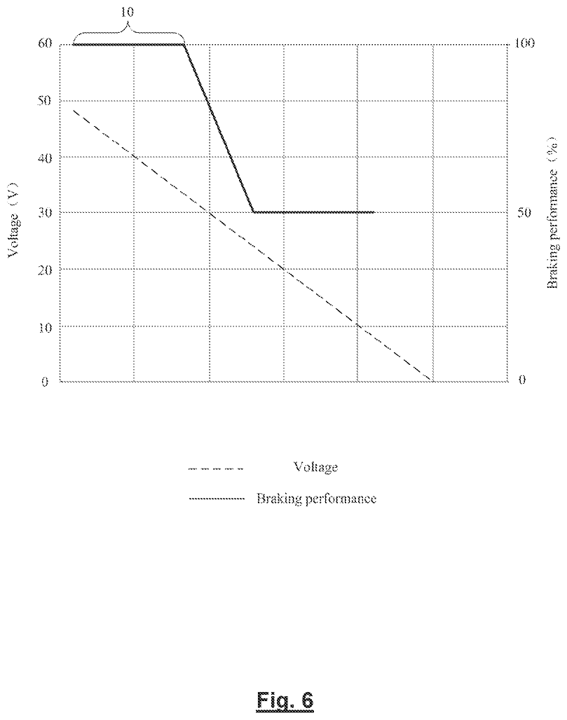

As shown in FIG. 6, an alternative solution is that, when the actual energy level of the capacitor-based power source is between the first predetermined threshold 30 and the second predetermined threshold 40, different from the braking performance is always set to a predetermined level, the braking performance is adjusted in a manner that at least partially correlates with the actual energy level. For example, the braking performance is linearly correlated with the actual energy level in the range from 100% to 50%, thereby gradually reducing the braking performance so as to avoid causing maladjustment to the drive due to the sudden change of the braking performance.

As another embodiment, the electromechanical brake system 7 further comprises an alarm module 6. The alarm module 6 is communicatively connected to the ECU 1.

In this embodiment, the alarm module 6 can be implemented by using existing hardware devices such as a speaker, a display screen, and an alarm indicator. It is mainly used to prompt the driver. As long as the corresponding functions can be realized, the type of the alarm module 6 is not specifically limited, and the corresponding selection and adjustment can be performed according to actual conditions and user requirements.

The ECU 1 is configured to output a warning signal to the alarm module 6 when the actual energy level of the capacitor-based power source 2 is lower than a warning threshold to warn the driver that the system will reduce the braking performance, and to prompt the driver the low energy of the capacitor-based power source 2.

In this embodiment, the warning threshold is higher than the first predetermined threshold 30. For example, the warning threshold is set to 56% of the total amount of electricity. Certainly, the set value of the warning threshold is not specifically limited in this embodiment, and the corresponding adjustment can be performed according to actual conditions and user requirements.

In this embodiment, the second predetermined threshold 40, that is, the automatic stopping threshold is lower than the first predetermined threshold 30. Certainly, the set value of the automatic stopping threshold is not specifically limited in this embodiment, and the second predetermined threshold 40 may be set different from the automatic stopping threshold.

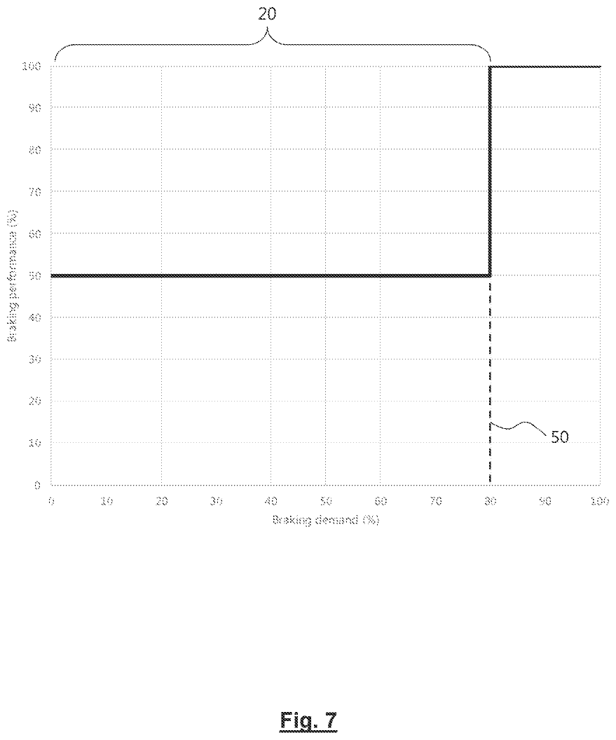

As another embodiment, as shown in FIG. 7, when the actual energy level of the power source 2 is lower than the first predetermined threshold 30, the braking performance of the electric brake device 4 is reduced to the second braking performance 20. However, in order to output normal braking force in an emergency, an predetermined emergency threshold 50 is set.

In this embodiment, the predetermined emergency threshold 50 is exemplarily set as 80% of the maximum braking demand. When the braking demand is from a brake pedal, it is correlated to the stroke of the brake pedal. When the braking demand is lower than the predetermined emergency threshold 50, the braking performance of the electric brake device 4 is reduced to the second braking performance 20 to warn the driver of the abnormality of the brake system. When the braking demand is higher than the predetermined emergency threshold 50, namely the braking demand indicated by the stroke of the brake pedal is higher than 80% of the maximum braking demand, the reduction of the braking performance of the electric brake device 4 is stopped. Therefore, the electric brake device 4 applies a normal braking force and/or a normal response time so as to avoid not being able to stop the vehicle quickly in an emergency due to the braking performance reduction.

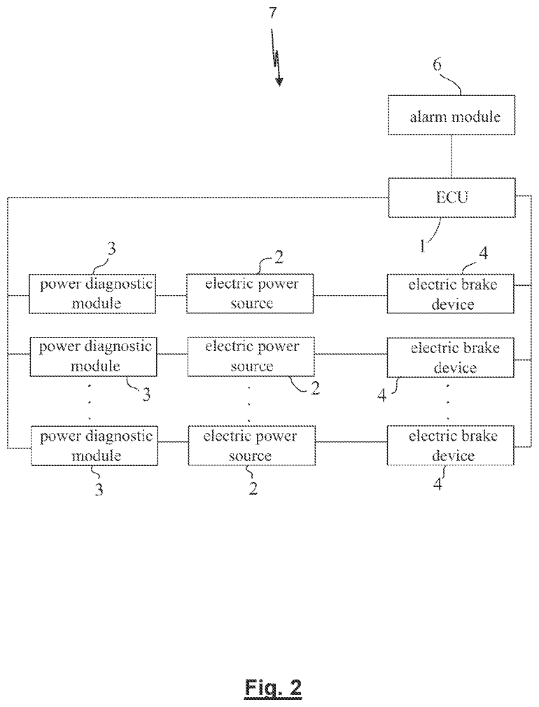

As another embodiment, as shown in FIG. 2, the electromechanical brake system 7 comprises a plurality of the electric power sources 2, each of the electric power sources 2 supplies power for at least one of the electric brake devices 4, each of the electric power sources 2 corresponds to a power diagnostic module 3, the power diagnostic module 3 is configured to detect the performance of the corresponding electric power source 2.

In this embodiment, the power diagnostic module 3 adjusts the predetermined threshold according to the performance of the corresponding electric power source 2 to improve the accuracy of controlling the brake system.

Specifically, the performance of the electric power source 2 will attenuate with the use time, and its power storage capacity will decrease, that is, the maximum power storage capacity will be reduced. When the predetermined threshold is set, the performance variation of the electric power source 2 needs to be considered. Therefore, in this embodiment, the predetermined threshold can also be appropriately adjusted according to the degree of attenuation of the electric power source 2.

When the electric power source 2 uses an ultra-capacitor group, its voltage value can be used to assess its actual energy level. When the electric power source 2 uses an energy storage battery, the actual energy level is calculated by comprehensively evaluating the performance of various parameters, such as voltage, charge and discharge current, temperature or ESR.

The ECU 1 is configured to reduce the braking performance of the electric brake device 4 powered by any one of the capacitor-based power sources 2 whose actual energy level is lower than the predetermined threshold or to reduce the braking performance of all of the electric brake devices 4 when the actual energy level of any one of the capacitor-based power sources 2 is lower than the predetermined threshold to simultaneously reduce the braking performance of all of the electric brake devices 4 to the same predetermined level.

Generally, a large vehicle is equipped with a plurality of electric power sources 2 and a plurality of electric brake devices 4, and the above-mentioned method for simultaneously reducing the braking performance is beneficial to the unified management of the electromechanical brake system 7, thereby effectively improving the management efficiency.

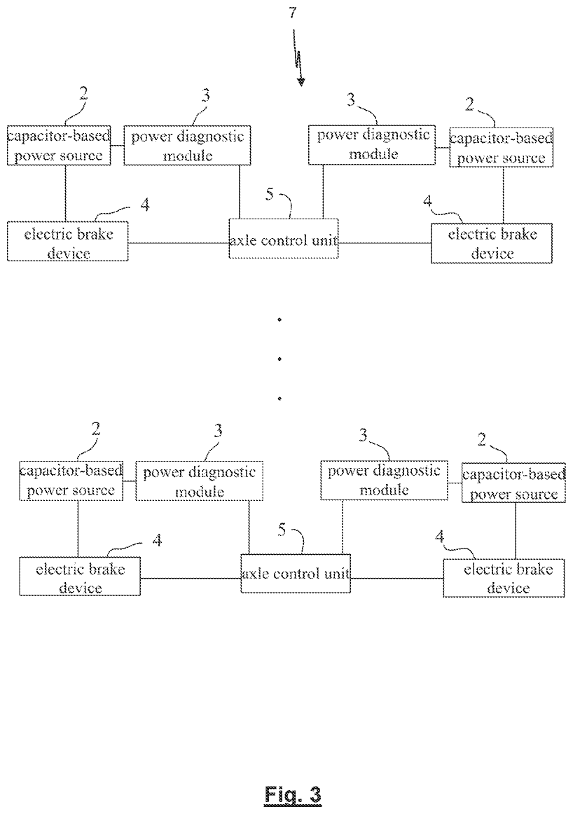

As another embodiment, as shown in FIG. 3, the electromechanical brake system 7 further comprises a plurality of axle control units 5, each axle control unit 5 corresponding to an axle, each axle control unit 5 controls at least one electric brake device 4 at each end of the axle.

The axle control unit 5 is configured to adjust the braking performance of the corresponding electric brake device 4 based on the received braking demand and the actual energy level of the electric power source 2. Exemplarily, each axle control unit 5 can integrate a capacitor-based power source 2 and its diagnostic module, and the axle control unit 5 controls the capacitor-based power source 2 to supply power for electric brake devices 4 at both ends of the axle instead of each electric brake device 4 is provided with a capacitor-based power source 2, thereby simplifying the system architecture.

The electromechanical brake system 7 provided by this embodiment can timely adjust the braking performance of the electric brake device and promptly inform the driver of the braking situation, so that the driver can obtain an intuitive braking feeling during the driving process, thereby effectively improving the safety of the vehicle, and at the same time it saves the energy of the electric power source and avoids unnecessary energy consumption, thereby playing a good role in protecting the electromechanical brake system 7.

The present invention further provides an embodiment of a control method of electromechanical brake system 7. The control method is implemented using an electromechanical brake system 7 as described above. The control method comprises, adjusting braking performance of the electric brake device according to an actual energy level of the electric power source, so that a driver can obtain an intuitive braking feeling during the driving process, thereby effectively improving the safety of the vehicle, and at the same time it saves the energy of the electric power source.

In this embodiment, the actual energy level corresponds to the remaining useful amount of energy in an energy storage device, and may also be a correlation index for measuring the remaining useful amount of energy of the energy storage device. As long as it can be used to measure the remaining useful amount of energy of the energy storage device, it can be set according to actual conditions and user requirements.

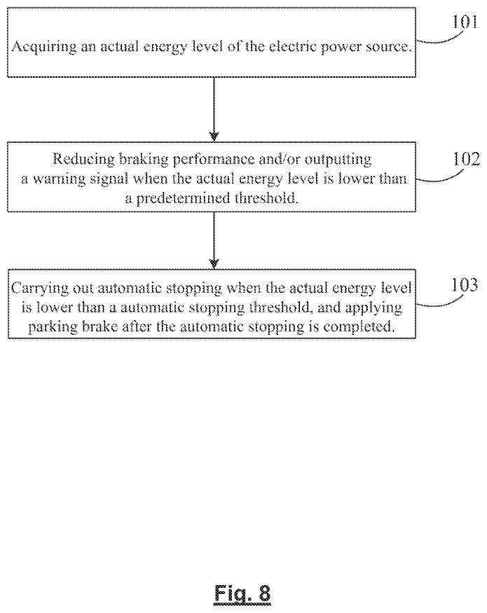

Specifically, as shown in FIG. 8, the control method comprises the following steps.

Step 101, acquiring an actual energy level of the electric power source.

In this embodiment, the electric power source comprises a capacitor-based power source and/or a battery as described above.

The electric power source, in addition to employ a centralized arrangement that a single power source supplying energy to each electric brake device, may also employ a distributed arrangement corresponding to the electric brake device. Or the electric brake device at each end of each axle is powered by one electric power source.

According to the centralized arrangement or the distributed arrangement of the electric power source, the power diagnostic module can also be arranged as one or more correspondingly.

In this step, the power diagnostic module detects the performance of the electric power source, and evaluates the power storage capability of the electric power source based on its performance, thereby more accurately determining the actual energy level of the electric power source.

As an embodiment, in this step, the power diagnostic module also sends the detected actual energy level to the ECU in real time.

Step 102, reducing braking performance and/or outputting a warning signal when the actual energy level is lower than a predetermined threshold.

In this step, the ECU adjusts braking performance of the electric brake device based on the received braking demand and the actual energy level of the electric power source.

The braking performance comprises braking force, that is, the braking force. The braking performance further comprises braking response time, or only comprises braking response time.

Specifically, the ECU acquires the actual energy level of the electric power source in real time, and reduces braking performance of the electric brake device when the actual energy level of the electric power source is lower than a predetermined threshold. The adjustment of the braking performance can be achieved by processing the braking demand obtained from the driver, for example, adjusting the signal acquired from the brake pedal, and also by controlling the electric brake device, for example, adjusting the control signal output to the electric brake device.

The predetermined threshold is not specifically limited in this embodiment, and the predetermined threshold may be set according to the hardware condition of the electromechanical brake system 7 and the user requirement, and the predetermined threshold may also be divided into multiple predetermined thresholds, to form multiple forms of adjustment.

In this step, as an embodiment, the electric power source employs the capacitor-based power source, such as an ultra-capacitor group. Depending on the characteristics of the ultra-capacitor group, its voltage value can be used to assess its actual energy level. As shown in FIG. 4, when the electric power source exemplarily employs 48 V ultra-capacitor group, the theoretical value of its actual energy level is as shown, for example, at a voltage of 24 V, its actual energy level is 25%. The braking performance is divided into two levels, a first braking performance 10 and a second braking performance 20, respectively.

As shown in FIG. 5, the braking performance is set to the first braking performance 10 when the actual energy level of the capacitor-based power source is higher than or equal to a first predetermined threshold 30 (e.g., set to 50%).

At the first braking performance 10, the electric brake device maintains 100% of the braking performance. At this time, the vehicle outputs a corresponding braking force according to the generated braking demand, and the driver obtains a normal braking feeling.

Typically, when the braking energy is consumed, the capacitor-based power source can replenish the energy from, such as the energy storage battery of the vehicle, so that its actual energy level is always maintained above the first predetermined threshold 30. When the brake system or the vehicle system is abnormal, and the capacitor-based power source cannot be replenished, the actual energy level of the capacitor-based power source is consumed below the first predetermined threshold 30, with the energy consumption of the brake. At this time, the ECU sets the braking performance to the second braking performance 20.

At the second braking performance 20, the braking performance of the electric brake device is reduced to a predetermined level, such as 50% of the braking performance, that is, the output of the braking force is dropped to 50% of the first braking performance 10 and/or the braking response time is extended to 200% of the first braking performance 10. At this time, the driver will obviously feel the decline in the braking performance when the driver depresses the brake pedal, thereby achieving the effect of prompting an abnormality of the brake system.

In this step, as an embodiment, as shown in FIG. 7, when the actual energy level of the power source 2 is lower than the first predetermined threshold 30, the braking performance of the electric brake device 4 is reduced to the second braking performance 20. However, in order to output normal braking force in an emergency, an predetermined emergency threshold 50 is set. In this embodiment, the predetermined emergency threshold 50 is exemplarily set as 80% of the maximum braking demand. When the braking demand is from a brake pedal, it's correlated to the stroke of the brake pedal. When the braking demand is lower than the predetermined emergency threshold 50, the braking performance of the electric brake device 4 is reduced to the second braking performance 20 to warn the driver of the abnormality of the brake system. When the braking demand is higher than the predetermined emergency threshold 50, namely the braking demand indicated by the stroke of the brake pedal is higher than 80% of the maximum braking demand, the reduction of the braking performance of the electric brake device 4 is stopped. Therefore, the electric brake device 4 applies a normal braking force and/or a normal response time so as to avoid not being able to stop the vehicle quickly in an emergency due to the braking performance reduction.

As shown in FIG. 6, an alternative solution is that, when the actual energy level of the capacitor-based power source is between the first predetermined threshold 30 and the second predetermined threshold 40, different from the braking performance is always set to a predetermined level, the braking performance is adjusted in a manner that at least partially correlates with the actual energy level. For example, the braking performance is linearly correlated with the actual energy level in the range from 100% to 50%, thereby gradually reducing the braking performance so as to avoid causing maladjustment to the drive due to the sudden change of the braking performance.

As another embodiment, the electromechanical brake system 7 further comprises an alarm module. The alarm module is communicatively connected to the ECU.

In this embodiment, the alarm module can be implemented by using existing hardware devices such as a speaker, a display screen, and an alarm indicator. It is mainly used to prompt the driver. As long as the corresponding functions can be realized, the type of the alarm module is not specifically limited, and the corresponding selection and adjustment can be performed according to actual conditions and user requirements.

In this step, outputting a warning signal to the alarm module when the actual energy level of the capacitor-based power source is lower than a warning threshold to warn the driver that the system will reduce the braking performance and to prompt the driver the low energy of the capacitor-based power source.

In this embodiment, the warning threshold is higher than the first predetermined threshold 30. For example, the warning threshold is set to 56% of the total amount of electricity. Certainly, the set value of the warning threshold is not specifically limited in this embodiment, and the corresponding adjustment can be performed according to actual conditions and user requirements.

Step 103, carrying out automatic stopping when the actual energy level is lower than a automatic stopping threshold, and applying parking brake after the automatic stopping is completed.

In this step, when the driver feels that the brake system is abnormal, braking is usually performed to stop the vehicle to ensure safety. By setting an appropriate first predetermined threshold 30, it is possible to ensure that its actual energy level is sufficient to fully brake the vehicle until it is stationary. However, if the driver cannot brake at this time, or if other abnormalities in the system cause the driver's brake input to be unsuccessful, the brake system needs to be forcedly braked.

For example, when the actual energy level of the capacitor-based power source is lower than the first predetermined threshold 30 and continues to decrease, if the vehicle is not stopped, a huge safety hazard may occur when the actual energy level drops to the point where the vehicle cannot be stopped. Therefore, a second predetermined threshold 40 is set (e.g., set to 25% of the total amount of electricity), and when the actual energy level continues to decrease below the second predetermined threshold 40, the brake system enforces automatic stopping, that is, utilizes the remaining charge decelerates the vehicle to a complete standstill. Therefore, the second predetermined threshold 40 is also the automatic stopping threshold, which should be set to ensure that its corresponding actual energy level is sufficient to completely stop the vehicle. After the vehicle is completely stopped, in order to further increase safety, a parking brake can also be applied. In the case where the electric brake device is integrated with the parking brake function, it can be used directly for parking brake, or an additional parking brake device can be used for applying parking brake.

In this embodiment, the second predetermined threshold 40, that is, the automatic stopping threshold is lower than the first predetermined threshold 30. Certainly, the set value of the automatic stopping threshold is not specifically limited in this embodiment, and the second predetermined threshold 40 may be set different from the automatic stopping threshold.

As another embodiment, the electromechanical brake system 7 comprises a plurality of the electric power sources, each of the electric power sources supplies power for at least one of the electric brake devices, each of the electric power sources corresponds to a power diagnostic module, the power diagnostic module detects the performance of the corresponding electric power source.

The control method further comprises the following steps.

The power diagnostic module adjusts the predetermined threshold according to the performance of the corresponding electric power source to improve the accuracy of controlling the brake system.

Specifically, the performance of the electric power source will attenuate with the use time, and its power storage capacity will decrease, that is, the maximum power storage capacity will be reduced. When the predetermined threshold is set, the performance variation of the electric power source needs to be considered. Therefore, in this embodiment, the predetermined threshold can also be appropriately adjusted according to the degree of attenuation of the electric power source.

When the electric power source uses an ultra-capacitor group, its voltage value can be used to assess its actual energy level. When the electric power source uses an energy storage battery, the actual energy level is calculated by comprehensively evaluating the performance of various parameters, such as voltage, charge and discharge current, temperature or ESR.

The control method further comprises the following steps.

The ECU reduces the braking performance of the electric brake device powered by any one of the capacitor-based power sources whose actual energy level is lower than the predetermined threshold or reduces the braking performance of all of the electric brake devices when the actual energy level of any one of the capacitor-based power sources is lower than the predetermined threshold to simultaneously reduce the braking performance of all of the electric brake devices to the same predetermined level.

Generally, a large vehicle is equipped with a plurality of electric power sources and a plurality of electric brake devices, and the above-mentioned method for simultaneously reducing the braking performance is beneficial to the unified management of the electromechanical brake system 7, thereby effectively improving the management efficiency.

As another embodiment, the electromechanical brake system 7 further comprises a plurality of axle control units, each axle control unit corresponding to an axle, each axle control unit controls at least one electric brake device at each end of the axle.

The control method further comprises the following steps.

The axle control unit adjusts the braking performance of the corresponding electric brake device based on the received braking demand and the actual energy level of the electric power source.

The present invention further provides an embodiment of a computer readable medium, having stored thereon computer instructions that, when executed by a processor, implement the steps of the control method of the electromechanical brake system 7.

The control method of electromechanical brake system 7 provided by this embodiment can timely adjust the braking performance of the electric brake device and promptly inform the driver of the braking situation, so that the driver can obtain an intuitive braking feeling during the driving process, thereby effectively improving the safety of the vehicle, and at the same time it saves the energy of the electric power source and avoids unnecessary energy consumption, thereby playing a good role in protecting the electromechanical brake system 7.

Service brake is intended to decelerate or stop the vehicle, which is typically operated by the driver via brake pedal or controlled by non-human driving system. Parking brake is intended to ensure that a stopped vehicle remains stationary, which is typically operated by the driver via parking switch. In addition to service brake, the electromechanical brake system 7 and the control method thereof provided by the present invention also apply to parking brake.

An exemplary embodiment is provided. When the brake system or the vehicle system is abnormal, and the capacitor-based power source cannot be replenished, the actual energy level of the capacitor-based power source is consumed below a predetermined threshold, with the energy consumption of the brake. At this time, the brake controller adjusts the braking performance of the brake devices integrated with parking brake function, e.g. by extending the response time to parking brake request, so that the driver can intuitively feel the delay of applying or releasing parking brake when operating the parking switch, thereby achieving the effect of prompting an abnormality to the driver.

Although the method is illustrated and described as a series of acts for the purpose of simplification of the explanation, it should be understood and appreciated that the methods are not limited by the order of the acts, as some acts may be in a different order according to one or more embodiments. Occurs and/or occurs concurrently with other acts from what is illustrated and described herein or that are not illustrated and described herein, but which can be understood by those skilled in the art.

The previous description of the disclosure is provided to enable any person skilled in the art to make or use the disclosure. Various modifications to the present disclosure will be obvious to those skilled in the art, and the general principles defined herein may be applied to other variations without departing from the spirit or scope of the disclosure. The present disclosure is not intended to be limited to the examples and designs described herein, but rather the broadest scope of the principles and novel features disclosed herein.

Many variations and modifications may be made to the preferred embodiments of the invention without departing substantially from the spirit and principles of the invention. All such modifications and variations are intended to be included herein within the scope of the present invention, as defined by the following claims.

We claim:

1. An electromechanical brake system, the electromechanical brake system comprising an electric power source and at least one electric brake device powered by the electric power source to generate a braking force responsive to a braking demand, wherein the electromechanical brake system is configured to adjust braking performance of the electric brake device according to an actual energy level of the electric power source.

2. The electromechanical brake system of claim 1, wherein the electromechanical brake system is configured to reduce braking performance of the electric brake device when the actual energy level of the electric power source is lower than a predetermined threshold.

3. The electromechanical brake system of claim 2, wherein the electromechanical brake system is configured to stop reducing the braking performance of the electric brake device when the braking demand is higher than a predetermined emergency threshold.

4. The electromechanical brake system of claim 2, wherein the electromechanical brake system comprises a power diagnostic module for detecting the actual energy level and/or a performance of the electric power source.

5. The electromechanical brake system of claim 2, wherein the braking performance is reduced to a predetermined level.

6. The electromechanical brake system of claim 2, wherein the electromechanical brake system is configured to output a warning signal when the actual energy level of the electric power source is lower than a warning threshold, the warning threshold being higher than the predetermined threshold.

7. The electromechanical brake system of claim 2, wherein the electromechanical brake system is configured to carry out automatic stopping when the actual energy level of the electric power source is lower than an automatic stopping threshold, the automatic stopping threshold is lower than the predetermined threshold.

8. The electromechanical brake system of claim 7, wherein a parking brake is applied after the automatic stopping is completed.

9. The electromechanical brake system of claim 1, wherein the braking performance comprises braking force and/or braking response time.

10. The electromechanical brake system of claim 2, wherein the braking performance comprises braking force and/or braking response time.

11. The electromechanical brake system of claim 2, wherein the electromechanical brake system comprises a plurality of the electric power sources, each of the electric power sources supplies power for at least one of the electric brake devices,
the electromechanical brake system is configured to reduce braking performance of the electric brake device powered by any one of the electric power sources whose actual energy level is lower than the predetermined threshold or reduce braking performance of all of the electric brake devices when the actual energy level of any one of the electric power sources is lower than the predetermined threshold.

12. The electromechanical brake system of claim 1, wherein the electromechanical brake system comprises an ECU,
the ECU is configured to adjust braking performance of the electric brake device based on the received braking demand and the actual energy level of the electric power source.

13. The electromechanical brake system of claim 1, wherein the electromechanical brake system comprises an axle control unit corresponding to an axle, each axle control unit controls electric brake devices at both ends of the axle,
the axle control unit is configured to adjust braking performance of the electric brake device based on the received braking demand and the actual energy level of the electric power source.

14. The electromechanical brake system of claim 1, wherein the electric power source comprises a capacitor-based power source and/or a battery.

15. A control method of electromechanical brake system, the electromechanical brake system comprising an electric power source and at least one electric brake device powered by the electric power source to generate a braking force responsive to a braking demand, wherein the control method comprises adjusting braking performance of the electric brake device according to an actual energy level of the electric power source.

16. The control method of claim 15, wherein the adjusting braking performance of the electric brake device according to an actual energy level of the electric power source comprises reducing braking performance of the electric brake device when the actual energy level of the electric power source is lower than a predetermined threshold.

17. The control method of claim 16, wherein the control method further comprises stopping to reduce the braking performance of the electric brake device when the braking demand is higher than a predetermined emergency threshold.

18. The control method of claim 16, wherein the control method further comprises detecting the actual energy level and/or a performance of the electric power source through a power diagnostic module.

19. The control method of claim 16, wherein the reducing braking performance of the electric brake device comprises the braking performance being reduced to a predetermined level.

20. The control method of claim 16, wherein the control method further comprises outputting a warning signal when the actual energy level of the electric power source is lower than a warning threshold, the warning threshold being higher than the predetermined threshold.

21. The control method of claim 16, wherein the control method further comprises carrying out automatic stopping when the actual energy level of the electric power source is lower than an automatic stopping threshold, the automatic stopping threshold being lower than the predetermined threshold.

22. The control method of claim 21, wherein a parking brake is applied after the automatic stopping is completed.

23. The control method of claim 15, wherein the braking performance comprises braking force and/or braking response time.

24. The control method of claim 16, wherein the electromechanical brake system comprises a plurality of the electric power sources, each of the electric power sources supplies power for at least one of the electric brake devices,
the adjusting braking performance of the electric brake device according to an actual energy level of the electric power source comprises reducing braking performance of the electric brake device powered by any one of the electric power sources whose actual energy level is lower than the predetermined threshold or reducing braking performance of all of the electric brake devices when the actual energy level of any one of the electric power sources is lower than the predetermined threshold.

25. The control method of claim 15, wherein the electromechanical brake system comprises an ECU,
the control method comprises adjusting, by the ECU, braking performance of the electric brake device based on the received braking demand and the actual energy level of the electric power source.

26. The control method of claim 15, wherein the electromechanical brake system comprises an axle control unit corresponding to an axle, each axle control unit controlling electric brake devices at both ends of the axle,
the control method comprises adjusting, by the axle control unit, braking performance of the electric brake device based on the received braking demand and the actual energy level of the electric power source.

27. The control method of claim 15, wherein the electric power source comprises a capacitor-based power source and/or a battery.

28. A computer readable medium with computer instructions or control logic stored thereon that, when executed by a processor, implement the steps of a control method of a electromechanical brake system comprising an electric power source and at least one electric brake device powered by the electric power source to generate a braking force responsive to a braking demand, the implemented steps comprising adjusting braking performance of the electric brake device according to an actual energy level of the electric power source.
